(19) United States
(12) Patent Application Publication
(10) Pub. No.: US 2014/0200085 A1
(43) Pub. Date: Jul. 17, 2014

(54) GAME CONTROLLER HAND GRIP FOR COUPLING WITH ASSOCIATED SUPPORT APPARATUS

(71) Applicants: WILLIAM BARES, JACKSON, MS (US); PETER BARES, LAFAYETTE, LA (US)

(72) Inventors: WILLIAM BARES, JACKSON, MS (US); PETER BARES, LAFAYETTE, LA (US)

(21) Appl. No.: 13/740,268

(22) Filed: Jan. 14, 2013

(51) Int. Cl. A63F 13/98

(52) U.S. Cl. CPC A63F 13/02
USPC 463/47; 273/148 B

(57) ABSTRACT

A hand grip provides a means to attach at least one hand-held game controller so that a user can with a single hand grasp of the hand grip and its attached game controller carry the hand grip while the fingers of that same hand can manipulate one or more actuators of said attached game controller while further carrying or operating appropriate supported equipment. The hand grip enables a user to assemble his or her own custom-built interactive, portable device by subsequently attaching various hand-held game controllers to appropriate support apparatus such as a camera support apparatus. Where said support apparatus may optionally and subsequently fixedly support appropriate supported equipment including a mobile computing device, a portable display, or motion-sensing equipment. The hand grip allows a user to arrange the hand grip(s) and any attached support apparatus or supported equipment in a variety of configurations that facilitate hand-held to shoulder-carried configurations.

### BACKGROUND OF THE INVENTION

(1) Field of the Invention

The field of this invention relates to hand-held game controllers and support apparatus to which said hand-held game controllers may be attached for the benefit of handling or operating said game controller in conjunction with said support apparatus. Said support apparatus may subsequently attach to, contain, or otherwise support the user's choice of desired equipment including any one of a portable display device, a mobile computing device, a tablet or slate computing device, or motion-sensing equipment.

(2) Description of Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Video game players commonly interact with entertainment software using hand-held game controllers that feature one or more actuators comprising any one or more of buttons or joysticks that generate a corresponding control signal when they are pressed. Some hand-held game controllers also feature embedded motion-sensing equipment that detects physical movement or turning of the entire game controller and generates a corresponding control signal. In some instances, a player may choose to install a hand-held game controller into a holder that is shaped to look or feel like an object that is related to the type of game being played such as a table-tennis racquet. Some existing game controller accessories help enhance one's grip while operating a game controller. Others provide improved aesthetics or ornamental design.

Portable game machines are hand-held devices that combine into a single integral package the compute processing, game control actuators, display device, and audio output. However, these devices integrate all components so a player cannot separately choose the control actuators, processing unit, display, nor customize its physical configuration such as the angle of the display screen in relation to the integrated game control actuators.

Mobile computing devices such as cellular telephones, tablets, or slate computers have become a popular platform for experiencing interactive software including video games due to their ubiquity, ease of mobility, and sufficient processing power and real-time graphics rendering capability. However, these mobile computing devices do not include hand-held game controllers since they would clutter the design of what are usually elegant, smooth slabs of glass and metal. One solution is to affix a joystick-shaped physical form onto the screen of the mobile computing device. As the user's fingers push this joystick-shaped form, pressure transferred from the finger causes the touch-sensitive screen of the mobile device to register a push gesture. However, this method cannot fully replicate the physical feel and the number and complexity of control actuators found in hand-held game controllers. In addition, affixing physical buttons and joysticks on-screen partially obscures part of the display and some such designs are subject to slipping loose during play. Another existing solution is to insert the mobile computing device into a specially-designed docking base that contains the physical buttons and joysticks. However, since the game controller actuators are embedded in the docking base, the player is not free to choose the type of game controller to use with his or her mobile computing device. The size and weight of the docking base may limit the ability of the player to move about while holding the docking base and installed mobile computing device. Some have devised adapters that can attach a game controller to a portable game device, to a cell phone, or to a portable display device. However, each of these solutions is intended to operate in a single anticipated physical configuration such as being held by both hands or with an anticipated type and model of attached device.

Professional video camera operators often utilize specialized support apparatus which we will refer to as camera support apparatus to assist in operating and handling video equipment that is attached to the support apparatus. Many forms of camera support apparatus are commercially available and include, but are not limited to, any combination of one or more of the following components: rods, clamps to attach one rod to another (sometimes at various angles), handles, articulated arms, shoulder pads, and further forms of support apparatus that may attach at least one piece of supported equipment to at least one component of a camera support apparatus. The desired components of camera support apparatus can be readily assembled into a wide variety of configurations to facilitate hand-held or shoulder-resting support for any optionally attached and appropriately-compatible supported equipment. Camera support apparatus typically conforms to industry standards such as the use of rigid, but lightweight cylindrical rods. The rods are commonly 15 millimeters in diameters, but other sizes may be used. These rods are commonly available in varying lengths and may be comprised of a strong, but lightweight material such as aluminum or carbon fiber.

Rod clamps are another commonly-used camera support assembly component. A rod clamp features at least one aperture whose diameter matches that of the rods. A rod clamp typically includes a hand-turned screw to loosen and tighten the clamp around a rod having been inserted into the aperture of the rod clamp. Multiple rods can be secured together into a wide variety of assemblages using one or more rod clamps. Some rod clamps feature more than one aperture, so more than one rod may be secured.

Many forms of equipment such as cameras may be attached to a camera support assembly using appropriate fasteners that are commonly in the form of a one-quarter inch-twenty threaded aperture or threaded bolt. The threaded apertures and threaded bolts are often one-quarter inch-twenty threaded, but other sizes and thread configurations may be used. For example, a rod clamp may provide a threaded aperture or threaded bolt onto which an appropriate piece of supported equipment such as a camera may be secured. Alternately, a rod clamp may secure a length of rod that is terminated by a threaded bolt, which in turn is used to secure a camera. Other forms of camera support apparatus components are possible such as the spring-loaded clamping frame seen in FIG. 2C, which is used to secure a mobile computing device. The clamping frame includes a threaded aperture that permits itself and the supported portable computing device to be in turn secured to a camera support assembly.

With respect to attaching hand-held game controllers to camera support apparatus or generally to other forms of support apparatus, existing game controllers are not designed with the intent of being mounted to support apparatus. Existing game controllers lack an appropriate mount feature (such as the threaded apertures or bolts found in camera support apparatus). Existing game controllers are typically constructed of lightweight plastics which are not strong enough to carry the weight of an attached support apparatus that may in turn carry additional supported equipment. Furthermore, some game controllers have irregular or curved shapes that do not afford their being attached to support apparatus. Many other forms of support apparatus presently exist and are commercially available including, for example, cases or sleeves that fully or partly enclose supported equipment including mobile computing devices. However, existing cases or sleeves designed to enclose supported equipment such as mobile computing devices, portable display screens, etc. provide no facility for attaching a game controller to be used in conjunction with the enclosed supported equipment.

Presently, no product exists that would enable a user to hold or operate a game controller with an associated support apparatus such that the following utility is provided: i) the fingers of one hand can manipulate the actuators of the attached game controller; and ii) simultaneously allowing the user to freely move or turn while carrying the associated support apparatus and any optionally supported equipment being carried by the support apparatus. A further desirable, but optional feature, is for a product that would enable the user to configure the game controller and associated support apparatus in a variety of handling or operating postures. Different postures include, but are not limited to, holding the game controller and associated support apparatus with a single hand, with two hands, or a combination of one or two hands and resting part of the support apparatus on the user's shoulders to better distribute the combined weight of the support assembly and any optional supported equipment installed in the support assembly. In yet other applications in which the user wishes to operate the supported equipment while holding it below his or her waist or above his or her shoulders, it would be desirable to have the ability to adjust the relative angle between any supported equipment (e.g., portable display device) and the game controller.

### OBJECTS AND SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Towards the object of improved game controller handling and additional objects that are made obvious in light of the present disclosure, a hand grip that can accept and attach a game controller for the purpose of handling or operating the user's choice of supported equipment while the user grasps at least one instance of the disclosed hand grip is provided. One preferred embodiment of the disclosed hand grip provides a means by which a support apparatus may be attached to said hand grip. Said support apparatus may attach, enclose, be coupled with or otherwise support a piece of supported equipment. Said supported equipment may include, but is not limited to, at least one of a variety of existing products including a portable display device, mobile computing device, slate computing device, tablet computing device, motion-sensing equipment, or a further support assembly. For example, a user may attach two instances of hand grips to an industry-standard camera support apparatus. Such an exemplar embodiment of the disclosed hand grip would comprise at least one appropriate mount feature to attach the hand grip to the camera support assembly. The user could then freely adjust the camera support assembly as desired to subsequently support a mobile computing device, for example. The user could then enjoy the utility of handling or operating the mobile computing device in conjunction with two game controllers, where each of the two controllers is attached to a hand grip placed on either side of the supported mobile computing device. The disclosed hand grip in all preferred embodiments is designed so that a user can simultaneously grasp a hand grip while his or her fingers can freely manipulate any one or more actuators that may be provided by the attached game controller with a same or other hand, and while he or she is able to carry or operate any optionally attached support apparatus and any further optional supported equipment held by said support apparatus in a coupling with, wearing by or attachment to the user's trunk or limbs.

One preferred embodiment of the disclosed hand grip comprises an integrated form that includes at least one hand grip and a support assembly. In the case of this integrated embodiment, particular variants on this concept could place mount features at least on the integral support assembly, or at least on at least one integral hand grip, or on both the integral support assembly and on at least one integral hand grip. For example, an embodiment of this integrated concept might feature two hand grips, each of which can accept and attach a game controller, and an integral support assembly in the form of a crossbar that joins and separates each hand grip by a sufficient distance so that a desired mobile computing device may be attached between the hand grips. This exemplar crossbar may in one instance be molded of the same piece of material as the two hand grips or the opposing ends of the crossbar may be integrally joined to each hand grip by a form of ratcheted ball and socket joint that would permit some degree of adjustment of the angle between the integral hand grip and the integral crossbar. The mobile computing device could be supported by a separate form of support apparatus such as an articulated arm, one end of which may attach to a mount feature on the crossbar and the other to the mobile computing device or an appropriate case that encloses the mobile computing device.

The following summarizes general characteristics desirable of the various disclosed preferred embodiments. A hand grip in this disclosure is shaped and sized to be proportionate to the space enclosed by the four curled fingers of a single human hand, and may generally be, in whole or in part, rectangular, bar-shaped or cylindrical form in certain preferred embodiments of the present invention. Optionally, alternatively or additionally the invented hand grip is shaped and sized to be proportionate to the space enclosed by the four curled fingers of a single human hand while coupled with a game controller or a mobile computing device. Still additionally, optionally or alternatively the invented hand grip may shaped and sized to be proportionate to the space enclosed by the four curled fingers of an adult single human adult hand while coupled with a game controller or a mobile computing device, in the alternative the invented hand grip may shaped and sized to be proportionate to the space enclosed by the four curled fingers of a single human child's hand while coupled with a game controller or a mobile computing device A hand grip in this disclosure is sized and shaped so as to offer a seating surface that contacts at least one surface of a game controller. A hand grip in this disclosure provides one or more means (employed singly or in combination) to accomplish the function of attaching a hand-held game controller to a hand grip. Embodiments of a hand grip may therefore utilize a seating surface made of or coated by a material that resists movement of said game controller while it is in contact with said seating surface, a seating surface having a concave shape that helps keep the game controller from moving out of contact with the seating surface, a seating surface having sides that apply pressure on opposing sides of the installed game controller, or a fastening mechanism that applies pressure onto the game controller to press it fixedly into contact with the seating surface. A hand grip in this disclosure is shaped such that a user's fingers can freely access and manipulate any one or more of the actuators of a game controller while it is fixedly attached to said hand grip. A hand grip in this disclosure is shaped and sized so that a user can securely grasp the hand grip and an attached game controller while the fingers of this same grasping hand simultaneously contact or manipulate any one or more actuators provided by the attached game controller and while the user is free to move about carrying the support apparatus that is optionally attached to said hand grip and in turn any optionally attached supported equipment. In descriptions of embodiments that integrate hand grip and support apparatus, it is understood that appropriate references to properties of a hand grip such having a seating surface to accept a game controller can be read as to also apply to any portion of the integral hand grip and support assembly embodiment at which the user will grasp with his or her hand.

The means for attaching a separate support apparatus to a mount feature may, for example, consist of an appropriate threaded aperture, threaded bolt, clamping mechanism, magnetic lock, or other mechanisms that provide a similar function. In another embodiment of the disclosed hand grip, the hand grip's mount feature may be an appropriately compatible point of contact which affords itself to being secured by the mount feature mechanism of a support apparatus.

This disclosure does not claim game controllers, industry-standard camera support assemblies, nor supported equipment such as mobile computing devices, portable display screens, or motion-tracking equipment all of which are known to prior art and commercially available. Examples of these work pieces will appear in the disclosed figures for the purpose of providing examples of how embodiments of the disclosed hand grip may be put into practical use.

### BRIEF DESCRIPTION OF THE SEVERAL VIEWS OF THE DRAWINGS

FIG. 1A. Side view of the first embodiment of the hand grip with seating surface appropriately shaped to receive a hand-held game controller. In this example the seating surface is curved and concave to afford a compatible match for the underside of the game controller shown.

FIG. 1B. Side and overhead views of first embodiment of hand grip seen in the previous figure.

FIG. 2A. Perspective view of second embodiment of the hand grip with largely flat seating surface.

FIG. 2B. Side view of a second embodiment of the hand grip shown with optional straps added to help secure a game controller to the hand grip.

FIG. 2C. Front view of a second embodiment of the hand grip (with attached game controller) attached to a support apparatus consisting of a cylindrical rod, rod clamps, a rubberized handle, and a clamping frame that secures a mobile computing device to the support apparatus.

FIG. 2D. Side and overhead views of a second embodiment of the invented hand grip.

FIG. 3A. Perspective view of a third embodiment of the hand grip having a seating surface whose raised sides help press against an installed game controller from opposing sides.

FIG. 3B. Perspective view of a third embodiment of the hand grip attached to a shoulder-carried camera support apparatus that in turn carries a portable display device and reflective motion-tracking markers. Since this embodiment offers a single mount feature at the lower end of the hand grip, additional camera support assembly components are used to lower the hand grip to the same level as a user's outstretched arm in front of his or her body.

FIG. 4A. Perspective view of a fourth embodiment as an integral design comprising of dual hand grips and a support apparatus bar that joins the two hand grips.

FIG. 4B. Perspective view of a fourth embodiment as an integral design where we see a game controller is attached to each of the hand grips. An articulated arm support apparatus is attached to the mount feature on the upper side of the integral support apparatus bar. The articulated arm in turn is attached to a second support apparatus, a clamping frame, which contains a mobile computing device. The example clamping frame offers a compatible mount for attachment to the articulated arm.

FIG. 4C. Perspective view of a variation of the fourth embodiment as an integral design where the mount feature comprises one or more slots into which is inserted an instance of supported equipment such as a tablet device.

### DETAILED DESCRIPTION

Certain new and special terms are used in the present disclosure and claims in describing various aspects of the invented method and invented processor, wherein these terms include the following:

As used in this description and the appended claims, the phrase “actuator” includes a form of physical input device such as a button or joystick that is operated by pressure caused by a human finger or thumb or a touch-sensitive surface that responds to taps or other finger gestures. For example, in the case of a device such as an IPHONE marketed by Apple, Inc. of Cupertino, Calif., an integral touch sensitive display thereof may show one or more symbols that respond to touch.

As used in this description and the appended claims, the phrase “button” is an actuator that when pressed generates a control signal to indicate that it has been pressed. A digital button produces a control signal that is one of two possible states—pressed or not pressed. An analog button produces a control signal that is in proportion to the amount by which the button is depressed.

As used in this description and the appended claims, the phrase “camera support apparatus” is a specialized and industry-standardized type of support apparatus consisting of any combination of one or more rigid cylindrical rods, rod clamps with at least one aperture to accommodate said rods, threaded apertures, threaded bolts, articulated arms, and any other forms of equipment or accessories that may be attached to any of the aforementioned components. It should be understood that a camera support apparatus is disclosed as an instructive example of the concept of a support apparatus and is not intended to restrict the meaning of support apparatus. Due to the use of modular and standardized components, a camera support assembly can be readily assembled in a variety of configurations from hand held to shoulder carried and can fixedly support many types of supported equipment that provide an appropriate mount feature (for example, ¼-inch threaded aperture). It should be understood that comparable components may have different measurements due to variations in manufacturing process. It should also be understood that this definition also includes proprietary components that may be used to a comparable or equivalent function.

As used in this description and the appended claims, the phrase “control signal” includes an electronic signal that is transmitted from an actuator or motion-sensing equipment to a compute processor over a wired or wireless connection for the purpose of enabling a user to signal some desired action to interactive software running on a compute processor.

As used in this description and the appended claims, the phrase “computer processor” includes an electronic component that is able to process stored-program instructions.

As used in this description and the appended claims, the phrase “fixedly support” includes, but is not limited to, attaching, connecting, enclosing, inserting, be coupled with, or otherwise supporting at least one piece of supported equipment by an appropriate support apparatus.

As used in this description and the appended claims, the phrase “game controller” includes a hand-held human input device that includes at least one mode of input comprising one or more actuators, touch-sensitive surface, pressure-sensitive surface, or some form of motion-sensing equipment that is intended to be held and operated by at least one human hand. For example, one game controller may comprise a single button, while a second comprises a motion sensor, and yet a third may comprise a button, a joystick, and a motion sensor, and so on. The game controller may be, in various preferred embodiments of the invented hand grip, a dedicated game controller or a multifunctional device, such as an IPHONE or IPOD marketed by Apple, Inc. of Cupertino, Calif. For purposes of this disclosure the term hand-held game controller may be used interchangeably since game controllers related to this disclosure are held by and operated by one or more hands.

As used in this description and the appended claims, the phrase “interactive software” includes software that runs on a computer processor such that the observed output produced by the software depends upon inputs made by a user such as inputs triggered by manipulating actuators or inputs detected by motion-sensing equipment.

As used in this description and the appended claims, the phrase “joystick” includes an actuator that can be displaced along at least one axis of movement. Most joysticks seen in games today generate an analog control signal to indicate the direction and magnitude of displacement. In contrast digital joysticks produce a control signal to indicate at least one or more directions of displacement (e.g. left and up).

As used in this description and the appended claims, the phrase “mobile computing device” includes a portable electronic device that includes a computer processor. This term may be generically applied to also include mobile telephones, tablet computing devices, slate computing devices, or portable game machines. Many mobile computing devices also feature a display and/or a touch-sensitive input surface.

As used in this description and the appended claims, the phrase “motion-sensing equipment” includes equipment which detects or contributes to the detection of motion of an entity. Equipment that can detect motion includes, but is not limited to, an optical camera or accelerometer or gyroscope. Equipment that contributes to the detection of motion includes, but is not limited to, passive (e.g. reflective spheres) or active markers (e.g. light emitting diodes) which are detected usually by optical cameras surrounding and aimed towards the anticipated area in which motion will occur.

As used in this description and the appended claims of the disclosed embodiments, the phrase “mount feature” includes a physical part or mechanism which has the ability to fixedly attach one separate part A to another separate part B. Part A and part B each have their own respective and appropriately compatible mount features. Part A's mount feature may at least afford at a minimum an appropriately compatible point of contact at which the mount feature of the part B may contact and secure to the part A. For example, part A's mount feature may be a clamping mechanism which only requires that part B offer a suitable rigid surface to which part A's clamping mechanism can grasp. Alternately, each part's mount feature may comprise mutually compatible mechanisms that can be secured together. For example, if the part A's mount feature is a threaded aperture, then the part B's mount feature would be a compatible threaded bolt. For example, if part A is a rectangular block, part B's mount feature may be a slot of appropriate dimensions to secure an inserted part A. It may also be possible for a mount feature to comprise a mechanism such as an adjustable clamp, ball and socket, hydrostatic articulating arm, or other functionally equivalent mechanism that allows the user to vary the relative angle and or position between the two parts being attached.

As used in this description and the appended claims, the phrase “portable display device” includes an electronic output device that can display visuals and which can be moved about by a user.

As used in this description and the appended claims, the phrase “portable game machine” includes an electronic device capable of playing interactive game software that in one integrated package consists of a portable display device, compute processor, and also usually a hand-held game controller, and sometimes motion-sensing equipment.

As used in this description and the appended claims, the phrase “seating surface” includes an exposed surface of a disclosed hand grip that is sized and shaped to contact at least one surface of an appropriate game controller. Depending on the specific type or types of game controller to be contacted by the seating surface, the shape of the seating surface may vary accordingly to afford sufficient contact between said seating surface and game controller, contribute to keeping the game controller fixed in contact with the seating surface, and allowing the user to freely access the actuators of the game controller. For one type of game controller the seating surface may be largely flat; but, for another the seating surface may be concave and curved; but, for yet another the seating surface may comprise two or more surfaces which contact an installed game controller on at least one side or surface.

As used in this description and the appended claims, the phrase “slate computing device” includes a mobile computing device whose physical form is characterized by a rectangular slab shaped body with an integral display device. A slate is generally considered to be a larger and more powerful variant of a tablet computing device.

As used in this description and the appended claims, the phrase “support apparatus” is any single piece of equipment or assemblage of two or more pieces of equipment which can fixedly support, contain, be coupled with, or otherwise hold at least one piece of optional supported equipment. In this disclosure it is assumed that one might use a support apparatus for a time without any supported equipment and then later attach supported equipment. For the purpose of this disclosure a support apparatus affords itself to being attached to an embodiment of the disclosed hand grip.

As used in this description and the appended claims, the phrase “supported equipment” includes any equipment that may be optionally and fixedly supported by said support apparatus. Such forms of supported equipment include (but are not limited to) any one or more of the following or comparable items: mobile computing device, motion-sensing equipment, portable display device, portable game machine, slate computing device, tablet computing device, or in some cases a further instance of a support apparatus such as, for example, an articulated arm that in turn supports a case that encloses a mobile computing device.

As used in this description and the appended claims, the phrase “tablet computing device” includes a mobile computing device whose physical form is characterized by a usually thin rectangular slab shaped body with a touch-sensitive display device. Devices that refer to themselves as tablets are often less than two pounds in weight.

This detailed description begins by discussing desired features that are generally found in common in preferred embodiments of the discrete embodiments of the disclosed hand grip (those which do not comprise an integral support apparatus). The disclosed hand grip provides a means to fixedly attach at least one support apparatus to said hand grip so that a user may hold said support apparatus by grasping said hand grip; where said hand grip has at least one appropriately compatible mount feature to fixedly attach said support apparatus to said hand grip; and where said hand grip provides a means by which at least one hand-held game controller may be fixedly attached to said hand grip. The game controller may be, in various preferred embodiments of the invented hand grip, a dedicated game controller or a multifunctional device, such as an IPHONE marketed by Apple, Inc. of Cupertino, Calif.

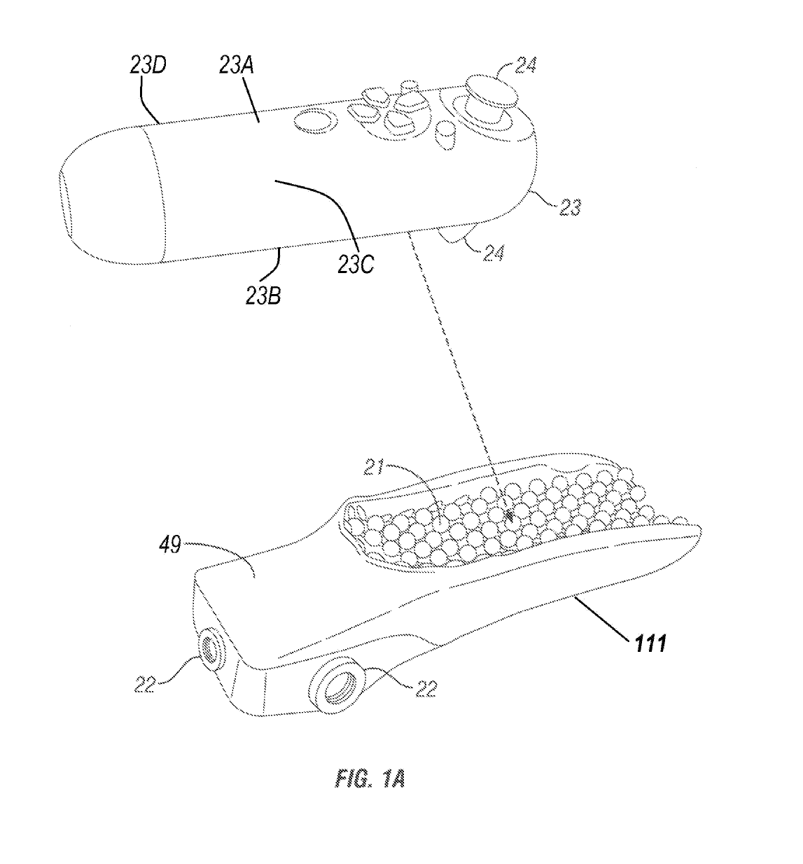

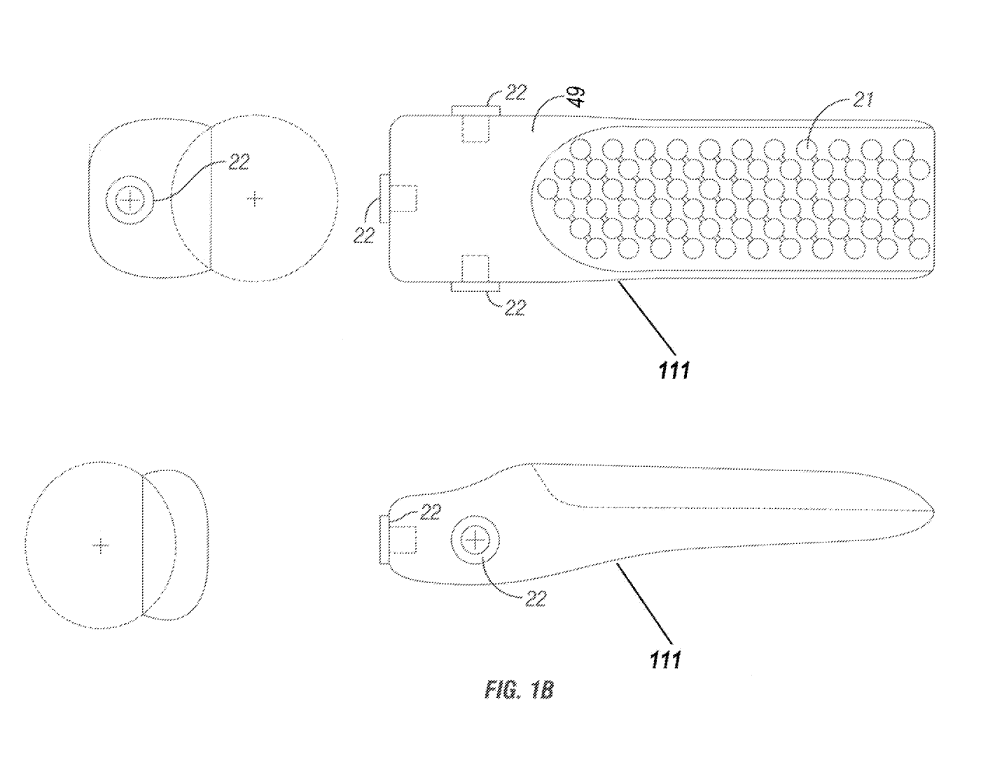

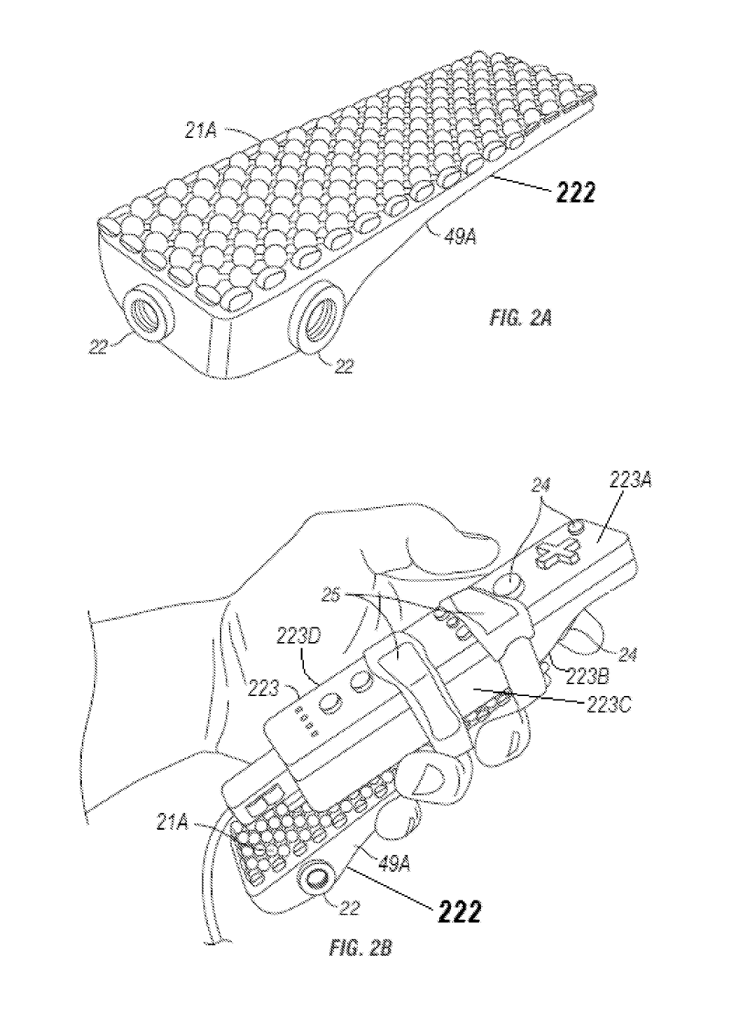

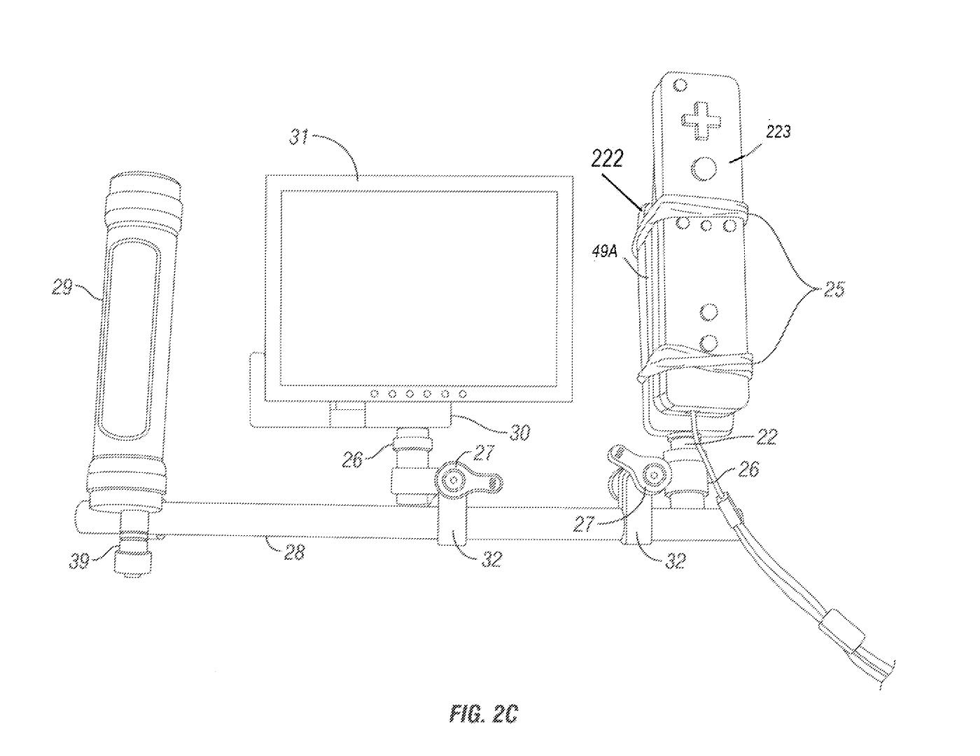

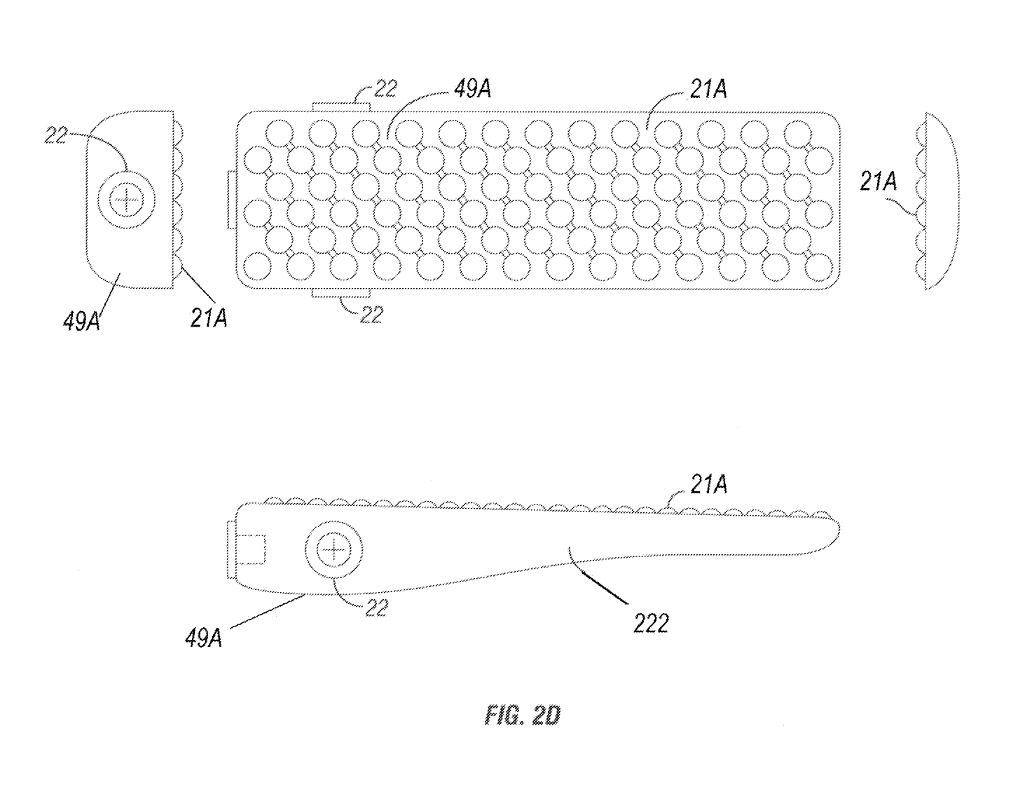

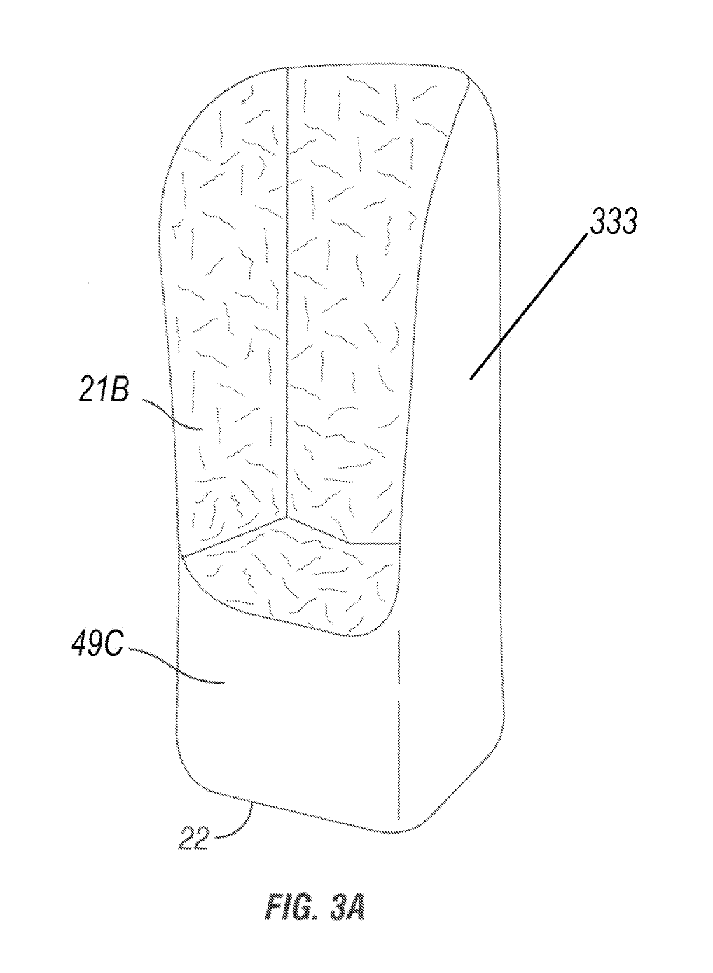

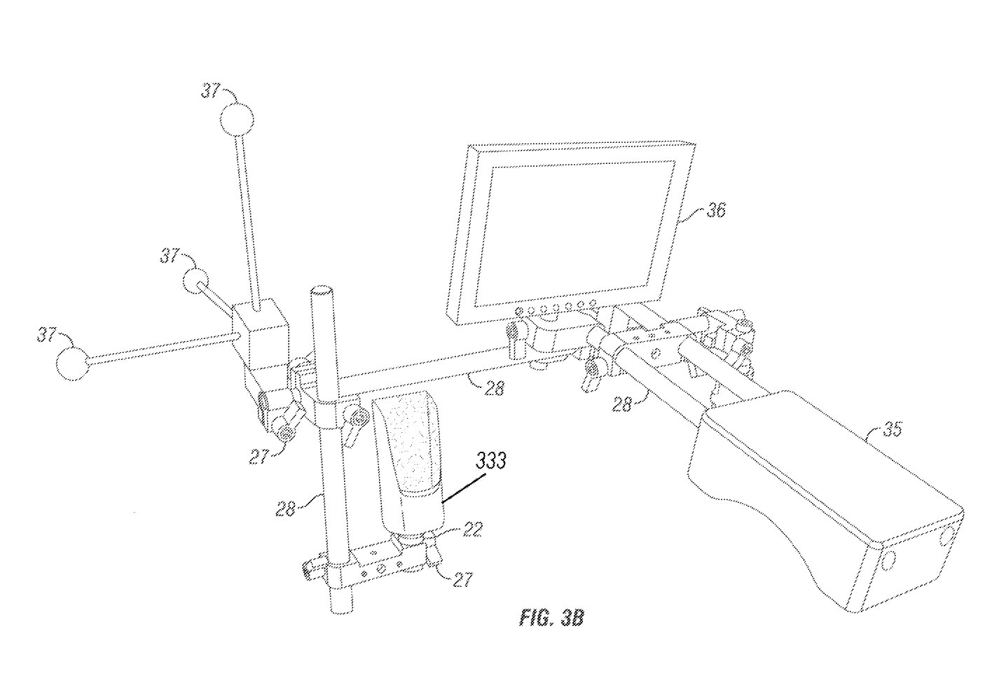

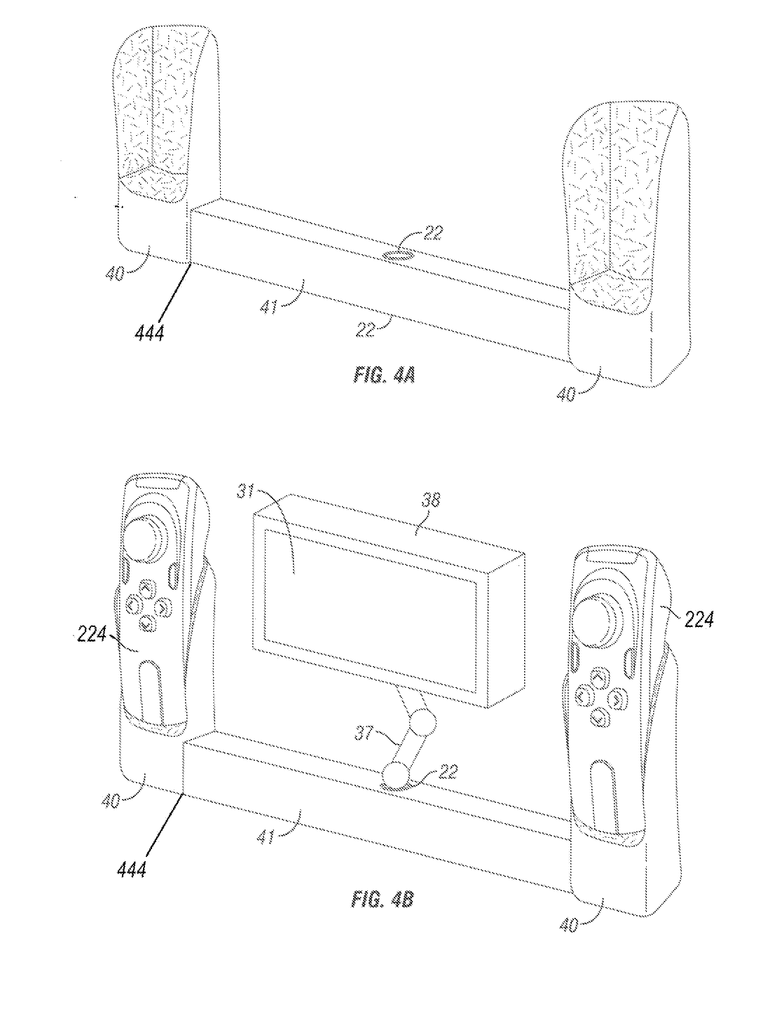

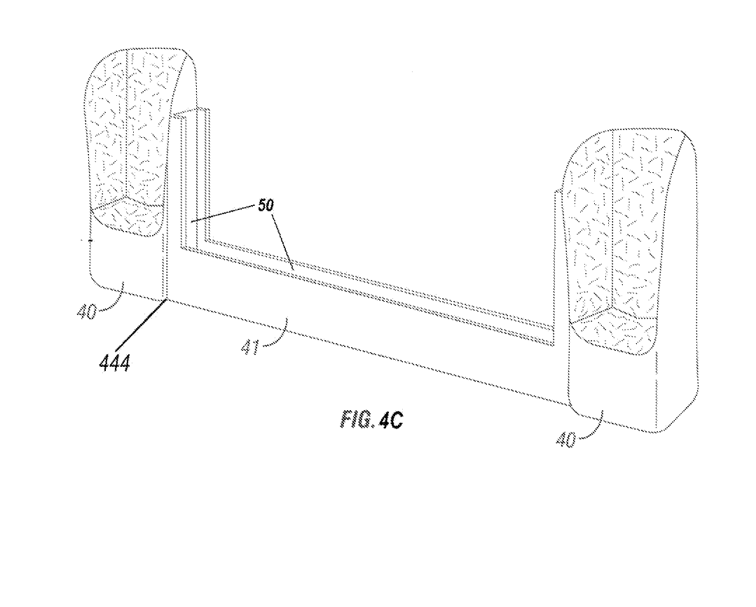

The disclosed hand grip is shaped and sized so as to be securely grasped by the clenching of at least one or more digits of at least one human hand. In the preferred embodiments the disclosed hand grip is shaped and sized to afford itself to be comfortably and securely grasped by at least one human hand of an adult or child whether or not an appropriate hand-held game controller is attached to said hand grip. In the preferred embodiments a body of the disclosed hand grip is constructed of at least one material, such as for example carbon fiber or aluminum, having sufficient strength and rigidity so that a user can carry or operate any supported equipment that is optionally supportably fixed to said support apparatus that is fixedly attached to said hand grip by grasping said disclosed hand grip with one or both hands. The hand grip body may be constructed using a variety of materials and methods, including but not limited to manufacture by an injection molding manufacturing process or even carved from a hardwood such as oak. The dimensions or proportions of embodiments of the disclosed hand grip may vary from those examples disclosed based on the factors including, but not limited to, the strength of the material of construction, nature of the mount features, size and shape of the game controller, and weight of optionally attached support apparatus and optional supported equipment. The example hand grips shown in the included FIGS. 1A, 1B, 2A, 2B, and 2C) were hand-carved from solid oak blocks with metal ¼-20 threaded inserts hammered into drilled tap holes and a tacky, compressible, rubberized padding glued onto the seating surface. The example handgrips shown in FIGS. 3A, 3B, 4A, and 4B were shaped from thermoplastic clay, which was then baked to harden. It is expected that construction using precision manufacturing processes and materials such as injection-molded carbon fiber polymers would yield thinner hand grips than those pictured.

Embodiments of the disclosed hand grip will vary by shape and size to afford at least one seating surface of contact between the hand grip and the specific type of game controller to be attached to said hand grip. The shape of the hand grip is such that the user's fingers and thumb may, without obstruction, touch and manipulate one or multiple actuators of the game controller while said game controller is attached to said hand grip and while the user simultaneously grasps said hand grip with said game controller attached to said hand grip. The disclosed hand grip includes at least one mount feature, which in preferred embodiments, is located at points on the hand grip such that when a support apparatus is attached to a mount feature of said hand grip, the user's arm, hand, and fingers are not obstructed by said attached support apparatus. When used with camera support apparatus, the mount features may comprise threaded apertures or threaded bolts so that any existing camera support apparatus components may be utilized. In constructing an embodiment of the disclosed hand grip, readily available machined, threaded metal inserts may be either molded into the hand grip form during manufacture or such an insert may be installed by drilling an appropriate aperture into the hand grip form and then tapping the insert securely into the hand grip.

The disclosed hand grip provides a means of holding a hand-held game controller fixedly to the hand grip's seating surface when said hand-held game controller is placed in contact with the disclosed hand grip's seating surface. Means of fixedly holding the game controller in contact to the hand grip's seating surface include, but are not limited to, application of any one or more of the following alone or in simultaneous combination: a seating surface made of material or coated by material that provides resistance to movement of the game controller, concavity of the seating surface that resists the game controller moving out of contact with said seating surface, pressure upon the installed game controller by two or more opposing sides of the disclosed hand grip's seating surface, or a means by which the game controller that is in contact with the hand grip's seating surface is pressed towards the disclosed hand grip.

In preferred embodiments the hand grip is shaped and sized such that its seating surface provides sufficient contact surface to help hold the installed game controller fixed, but leaving ample clearance for the user's hand to have unobstructed access to at least one (and ideally all of) the actuators of the installed game controller. The size of preferred embodiments of the hand grip should be relatively minimal so as to form a handle that can be securely grasped by one hand with or without an attached game controller. The hand grip should preferably add minimal size, thickness, or girth to the combination of hand grip and attached game controller so that a user can securely and comfortably grasp both with a single hand when a game controller is attached to said hand grip.

A further novel advantage of the disclosed hand grip is that a user may attach at least one of the disclosed hand grips to a support apparatus for the sole purpose of carrying or holding said support apparatus with or without an appropriate hand-held game controller attached to the disclosed hand grip.

FIG. 1A presents a first preferred embodiment of the disclosed hand grip 111, or first hand grip 111, that is adapted to receive an appropriately-shaped first hand-held game controller 23 having sides 23A-23D. A seating surface 21 on the first hand grip 111 is sized and shaped to match the size and shape of the exemplary first game controller 23, which happens to have the general shape of a cylinder. Consequently, the seating surface 21 is shaped as a curved concavity of a first body 49 of the first hand-grip 111 which will contribute to the function of keeping the first game controller 23 in contact with the seating surface. The seating surface 21 of this embodiment is coated with a tacky rubberized material that resists movement of the first game controller 23 as it contacts the seating surface 21. This pictured embodiment of the hand grip 111 includes three support mount features 22—one located on the right side, one located on the left side (not visible), and one located at the bottom end. In the first preferred embodiment, there are multiple mount features 22, each oriented in a different direction to allow a user to attach support apparatus in different physical configurations relative to the hand grip 111 as he or she freely chooses. In the exemplar preferred embodiment depicted in FIG. 1A, each of the three mount features 22 is in the form of a threaded aperture as is found in industry-standard camera support apparatuses.

FIG. 1B depicts overhead and side views of the first hand grip 111. The hand grip's 111 thickness gradually tapers down from its bottom end to its top end so as to facilitate a user being able to grasp both the hand grip 111 and attached compatible first game controller 23. The seating surface 21 of this first exemplar embodiment of the disclosed hand grip 111 comprises a cylindrical concavity to match the radius of the particular type of game controller 23 used. The depth of the concavity of the seating surface 21 is chosen so that it is sufficient to resist movement of the installed appropriately compatible game controller 23. In the example shown in FIG. 1B, the depth of the concavity is approximately half that of the radius of the intended game controller 23. It should be understood that this depth may vary as appropriate for different game controllers 23, or material composition of the hand grip 111, or the use of additional means to fix the game controller 23 to the hand grip's seating surface 21. However, the depth of a concavity in the seating surface 21 should be adapted so that the user's fingers may freely access any of the actuators of the installed game controller 23. The concave seating surface 21 is formed so that when the compatible game controller 23 is attached, the user's fingers can freely touch and operate all of its actuators including the “trigger” that is operated by the index finger and offer sufficient contact area between the game controller 23 and the seating surface 21 to contribute to keeping the game controller 23 in place on the seating surface 21. The seating surface 21 is shown coated by an optional slip-resistant rubber padding that contributes to keeping the game controller 23 in place while the user grasps the hand grip 111 and attached game controller 23. The combination of the concavity of the seating surface 21, slip-resistant coating of the seating surface 21, and pressure applied by the user's hand contribute to keeping the game controller 23 fixed into contact with the seating surface 21 of the hand grip 111.

FIG. 2A presents a second preferred embodiment 222 of the invented hand grip, or second hand grip 222. A second seating surface 21A of a second version body 49A of the second hand-grip 222 is substantially planar and adapted to accommodate a second game controller 223 having alternate sides 223A-223D, wherein the overall shape of the second hand-grip 222 is substantively shaped like an elongated rectangular bar. The seating surface 21A of this second preferred embodiment of the invented hand-grip 222 is coated with an optional tacky rubberized material that resists movement of the second game controller 223 in contact with the second seating surface 21A. This pictured second embodiment of the hand grip 222 includes three support mount features 22—one located on the right side, one located on the left side (not visible), one located at the bottom end. In this second preferred embodiment, there are multiple mount features 22, each oriented in a different direction to allow a user to attach support apparatus in different physical configurations relative to the hand grip 222. In the second embodiment depicted, each of the three mount features 22 is in the form of a threaded aperture as is found in industry-standard camera support apparatuses.

FIG. 2B shows a bottom side 223B of the second hand-held game controller 223 fixed into contact with the second seating surface 21A of the second preferred embodiment of the hand grip 222 with the help of added fastening mechanisms 25 that provide the function of pressing the second game controller 223 into contact with the hand grip 222. The one or more fastening mechanisms 25 should be placed so that they do not block access to the actuators 24, or they should include access apertures to allow access if the actuators 24 would be otherwise obstructed. The fastening mechanism 25 may be provided by an element that is entirely separate (and detachable) from the hand grip 222 (as is the case depicted in this figure) or the fastening mechanism 25 may be fixed to the hand grip 222. Note that a fastening mechanism 25 could also have been utilized with the first preferred embodiment 111 (FIGS. 1A and 1B). Examples of fastening mechanisms include any one or more of elastic straps, Velcro straps, a fastening mechanism built into the hand grip, a fastening mechanism built into the game controller, a cover plate that rests on and above an attached game controller and where said cover plate is secured to the hand grip, an adhesive, a sleeve that slips over the handgrip and installed game controller, or even screws drilled into the game controller and hand grip. Use of a fastening mechanism 25 with any given embodiment of the disclosed hand grip 111, 222, 333, or 444 is understood to be optional and its use is prescribed if the other means of fixing the game controller 23 to the hand grip 111, 222, 333, or 444 are not sufficient to keep the second game controller 223 fixedly in contact with the second seating surface 21A as the user manipulates the installed second game controller 223. As seen in this FIG. 2B, the width of this second preferred embodiment of the hand grip 222 is approximately equal to that of the second game controller 223 that the second preferred embodiment of the hand grip 222 will coupled with. Little or no additional width of the second hand grip 222 is called for since this second embodiment's second seating surface 21A does not provide a cavity or sides that attempt to partly or fully enclose the attached second game controller 223 on one or more sides 223A-223D.

FIG. 2C illustrates how the second preferred embodiment 222 of the disclosed hand grip and the second game controller 223 secured by fastening mechanisms 25 may be used in a hand-held configuration of an industry-standard camera support apparatus that is fixedly joined with a mobile computing device 31 to create a user-customized interactive game playing system. Note that in this example, the mobile computing device 31 is fixedly joined into an appropriate support apparatus 30 that comprises a spring-loaded clamping framework having an industry-standard threaded aperture. Note that this clamping framework and industry-standard camera support apparatus pictured are exemplary work pieces not claimed by this disclosure. The support apparatus 30 is secured to an industry-standard rod mount feature 26, which is in turn is secured by a rod clamp 32 to a rod 28 by turning the knob 27 of the rod clamp 32 in the appropriate direction. On the right of the figure, we see the second embodiment of the disclosed hand grip 222 secured by a rod mount feature 26 to a rod clamp 32, which is lastly secured to the rod 28. On the left side, we see an industry-standard rubberized handle 29 featuring an integrated rod clamp 39 that is secured to the rod 28. By providing preferred embodiments of the disclosed hand grip with support mount features 22 compatible with those found in industry standard camera support apparatuses, the disclosed hand grip affords itself to use with a wide variety of existing accessories such as smaller support apparatuses 30 designed to mount mobile computing devices 31 to industry-standard camera support apparatuses 30. It is to be understood that any embodiment of the disclosed hand grip 111, 222, or 333 having at least one appropriate support mount feature 22 at its bottom end may be likewise utilized by configuring an industry-standard camera support apparatus 30 and its supported equipment (e.g., mobile computing device 31) as shown in FIG. 2C. Furthermore, many more distinct physical configurations are possible by for example, replacing the industry-standard handle 29 with a second instance of the disclosed hand grip 111, 222, or 333. A larger mobile computing device 31 may be accommodated by substituting an appropriately larger support apparatus 30 to accommodate the fixedly joined mobile computing device 31. The disclosed figures are intended for example only and are not intended to suggest limits in the number of possible configurations afforded by appropriate support apparatuses or optional supported equipment. The disclosed figures of the preferred embodiments of the disclosed hand grip 111, 222, 333, or 444 each feature one or more mount features 22 that are threaded apertures, due to their simplicity of construction. However, it should be clear that given this disclosure, that an ordinary person skilled in the art can without undue experimentation, readily substitute a threaded aperture with a threaded bolt, or a short length of rod, or a rod clamp, or with another form of equivalent fastener or mount feature that implements the function of fixedly attaching the disclosed hand grip 111, 222, 333, or 444 to an appropriate support apparatus such as 30.

FIG. 2D is a side and overhead view for the second preferred embodiment 222 of the disclosed hand grip 111. The hand grip's thickness gradually tapers from its bottom end to its top end so as to add minimal apparent bulk to the attached second game controller 223 when the user grasps the hand grip 222 with the attached second game controller 223. The dimensions of this second preferred embodiment of the invented hand-grip 222 are designed to correspond to the dimensions of at least one particular second game controller 223. The second seating surface 21A of this second exemplar embodiment of the disclosed hand grip 222 comprises a flat surface coated by an optional slip-resistant rubber padding. Since second game controller 223 does not provide a concave first seating surface 21, it is recommended that a user apply an optional fastening mechanism 25 such as the straps shown in FIG. 2B to supplement the slip-resistant effect of the slip-resistant padding. The second game controller 223 should be ideally positioned on the second seating surface 21A so that the second game controller 223 can be adequately secured and allow the user's fingers to access any of the actuators 24 of the second game controller 223.

FIG. 3A presents a third preferred embodiment of the disclosed hand grip 333, or third grip 333 that is characterized by having a seating surface 21B that forms a cavity into which an appropriate hand-held game controller 223 may be inserted. For sake of example, we refer back to the exemplar rectangular bar-shaped game controller 223 having sides 223A (top), 223B (underside), 223C (right), and 223D (left) as was seen in FIG. 2B. This form of seating surface 21B provides the added function of having two raised sides of the seating surface 21B that contact the game controller 223 and act to press upon two opposing sides 223C and 223D of the inserted game controller 223 in addition to also contacting the underside 223B of said exemplar game controller. The resulting contact pressure from two opposing sides of the seating surface 21B contributes to holding the installed game controller 223 fixed inside the hand grip's 333 cavity-shaped seating surface 21B. It should be understood that the depth of this cavity may vary as appropriate for different game controllers 223, or material composition of the hand grip, or the use of additional means to fix the game controller 223 to the hand grip's 333 seating surface 21B. However, the depth of a concavity in the seating surface 21B should at most be generally less than or equal to the thickness of an installed game controller 223 so that the user's fingers may freely access any of the actuators 24 of the installed game controller 223. Optionally, the seating surface 21B may be further composed of or coated with a material that resists movement of the installed game controller 223. Optionally, a fastening mechanism 25 that provides a means by which at least one surface of the game controller 223 is pressed into at least one side of the seating surface 21B may be applied to further contribute to fixedly attaching the installed game controller 223 to the disclosed third embodiment of the hand grip 333. This body 49C of this third preferred embodiment has one mount feature 22 as a threaded aperture in the center of its underside (not visible in the illustrated perspective) that would accept a corresponding threaded bolt entering the aperture at a right angle to the not seen underside of this exemplar third preferred embodiment.

In general for the first (111), second (222), and third embodiments (333), the novel design of the disclosed hand grip allows a user to configure one or more instances of the disclosed hand grip 111, 222, or 333 so that he or she can securely hold the attached support apparatus 30 in the manner best suited for its handling, weight distribution, stability, balance, etc. For some types of optional supported equipment, a hand-held configuration may be best (See FIG. 2C). But for other applications, a user may choose to configure support apparatus 30 components in a shoulder-carried configuration as depicted in FIG. 3B. Such a configuration has the advantage of distributing the weight of the support apparatus, which in this example comprises camera support apparatus components 22, 27, 28, and 35 and any optional supported equipment over the one or more handgrips 333 and the user's shoulder. This shoulder-carried configuration also generally allows for a larger support apparatus 30 onto which more supported equipment can be attached such as reflective marker spheres 37 commonly used by optical motion-sensing cameras. Note the use of additional support assembly 30 components that are used to attach this example embodiment at its single underside mount feature 22 so that the hand grip 333 is positioned just below the long horizontal bar 28 just below the portable display 36 to provide better ergonomics for the shoulder-carried configuration in which a user would extend both arms straight ahead with at least one hand grasping this third embodiment of the disclosed hand grip 333. FIG. 3B depicts the hand grip 333 being used simply as a handle for carrying the support apparatus without a game controller installed.

One further, but not pictured, variant of the third embodiment of the hand grip 333 shown in FIG. 3A would be characterized by at least one side-located mount feature 22. A mount feature 22 placed on either the left or right side of the hand grip 333 near its top end makes it much easier to directly connect the hand grip 333 to a shoulder-carried support assembly 30 such as the one shown in FIG. 3B, in which the attached support assembly 30 approaches the hand grip 333 from above. Fewer support assembly 30 components would be needed to obtain the shoulder-carried configuration; however, placement of a side mount feature 22 on a given side may preclude placing a side mount feature 22 on the opposite side since the operator's fingers may curl from one side to the other and rest awkwardly against the opposing side mount feature 22. Consequently, this variation requires two distinct hand grips 333—one appropriately designed for the left hand (side mount feature 22 on right of hand grip 333) and a second hand grip 333 for the right hand (side mount feature 22 on left of hand grip 333). This variation would increase cost of manufacture and so is not considered an ideal or preferred embodiment, but is disclosed for sake of completeness.

The fourth preferred embodiment of the disclosed hand grip 444 or FOURTH GRIP 444 comprises an integrated mechanism that includes at least one integral hand grip 40 and support assembly 41 (See FIG. 4A). In the case of this integrated embodiment, particular variants on this concept could place mount features 22 only on the integral support assembly 41, or only on at least one integral hand grip 40, or on both the integral support assembly 41 and on at least one integral hand grip 40. For example, an embodiment of this integrated concept might feature two hand grips 40, each of which can accept and attach a game controller 224, and an integral support assembly in the form of a crossbar 41 that joins and separates each hand grip 40 by a sufficient distance so that a desired mobile computing device 31 may be attached between the hand grips 40. This exemplar crossbar 41 may in one instance be molded of the same piece of material as the two hand grips 40 or the opposing ends of the crossbar 41 may be integrally joined to each hand grip 40 by a form of mechanism that would permit some degree of adjustment of the relative angle between the integral hand grip 40 and the integral crossbar 41. FIG. 4B shows an example of a mobile computing device 31 supported by a separate form of support apparatus such as an articulated arm 37, one end of which may attach to a mount feature 22 on the crossbar 41 and the other to the mobile computing device 31 or an appropriate holder 38 (such as the spring-loaded clamping frame in FIG. 2C) that offers a compatible mount feature for the articulated arm 37. The user is free to configure the articulated arm 37 as he or she wishes so that the mobile computing device 31 is oriented at the desired viewing distance and angle relative to the game controller 224 installed in an embodiment of the disclosed hand grip 444.

One further variation on the integral form 444 is depicted in FIG. 4C. In this variation the integral form 444 is designed so that the mount feature comprises one or more slots 50 into which a mobile computing device, e.g. tablet device, may be installed such that the device is fixed between the hand grips 40. Alternatively, the mount feature of the integral form may comprise a cavity that is form-fitted to accept and hold a piece of supported equipment. For example, the space between the two hand grips 40 and crossbar 41 may consist of a rectangular block of material into which is cut a cavity sized and shaped to accept and securely hold an instance of supported equipment such as a tablet device. In each of these variants the respective mount feature may be optionally coated with or comprised of a substance that contributes to holding the installed supported equipment securely such as a tacky rubber padding or felt.

Regarding the integral form 444, all preceding descriptions of the construction of a single hand grip are applicable, except for the requirement of at least one mount feature on a hand grip since the integral support apparatus (e.g. crossbar 41) can include a mount feature 22. For example, the hand grip designs of the first 111 or second preferred embodiments 222 (See FIG. 1A or 2A) may be equivalently substituted into the integral form in place of hand grip 40 seen in FIG. 4A.

To enable useful application of the any of the disclosed embodiments of the hand grip 111, 222, 333, or 444, it is assumed that an ordinary person skilled in the art has the ability to appropriately write computer instructions that would enable control signals from a hand-held game controller 23 attached to said disclosed hand grip 111, 222, 333, or 444 to be communicated to a desired computer processor so that said computer processor would respond appropriately to said control signals. It should be understood that the writing of software programs related to the attached hand-held game controller and associated computer processor(s) is beyond the scope and responsibility of this disclosure relating to said disclosed hand grip 111, 222, 333, or 444 being a physical artifact that facilitates usage of a hand-held game controller such as exemplars 23 or 223 with any appropriate supported equipment.

With respect to any of the previously disclosed preferred embodiments of the disclosed hand grip 111, 222, 333, or 444, it should be possible for an ordinary person skilled in the art and without undue experiment to substitute any functionally equivalent forms of mount features 22, seating surfaces 21 or 21A, fastening mechanisms 25, or support apparatuses 30 that serve their respective equivalent functions as defined in this disclosure. Consequently, it should also be understood to an ordinary person skilled in the art can readily create additional embodiments of the disclosed hand grip 111, 222, 333, or 444 by selecting any combination of interchangeable and mutually consistent features including, but not limited to, variability of the size and shape of the hand grip 111, 222, 333, or 444 to conform to a desired hand-held game controller 23 & 223, the number, physical form, and location of mount features 22, the shape and nature of the seating surface 21, 21A & 21B to conform to and contribute to contacting the desired hand-held game controller 23, the presence or absence of material or coating on the seating surface 21, 21A & 21B to resist movement of an installed game controller 23, and the presence or absence of fastening mechanisms 25 that serve the function of pressing the installed game controller 23 fixedly into contact with the hand grip 111, 222, 333, or 444. For any of the disclosed embodiments, it is possible, but less than ideal to permanently fix a game controller 23 to a hand grip 111, 222, 333, or 444 using an adhesive or by drilling apertures to secure fasteners into a game controller 23 since the game controller 23 may be damaged.

Additional variations on the disclosed embodiments may feature any one or more of the following to enhance the utility:

i) add one or more apertures, depressions, or passages to allow cables or other protrusions of a game controller 23 to be attached to a given embodiment of the disclosed hand grip 111, 222, 333, or 444.

ii) a form that can be attached by some means any of the exemplar disclosed seating surface 21 so as to change the shape of the seating surface 21 to accommodate a differently shaped game controller 23. For example, a rectangular form with a cavity cut into it to fit the shape of an irregular or curved game controller 23 could be installed inside the largely rectangular seating surface 21B of the disclosed exemplar third embodiment hand grip 333. Such a rectangular form may be sized and shaped so as to contact the opposing sides of the seating surface 21B of the third embodiment hand grip 333 to facilitate holding said rectangular form fixed inside the seating surface 21B of the third embodiment seen in FIG. 3A. Alternately, a second rectangular form having a concave seating surface 21 such as the one seen in the first embodiment of the hand grip 111 as shown in FIG. 1A may be attached to the flat seating surface 21A of the embodiment seen in FIG. 2A. Such a rectangular form would have one flat side shaped and sized to mate to the flat seating surface 21A of the second embodiment of hand grip 222 as seen in FIG. 2A. Such a rectangular form would have a thickness sufficient to afford a concave seating surface 21 equivalent to the one seen in FIG. 1A. Means of attaching this second example of a rectangular form may include, but should not be limited to, fastening mechanisms 25 such as straps, adhesives, or protruding members such as pegs that fasten into apertures cut into the flat seating surface 21A of the second embodiment of hand grip 222 as seen in FIG. 2A.

It should be understood that the previously disclosed preferred embodiments and their illustrations are intended to serve as examples to instruct practitioners in implementing the disclosed hand grip invention. This document describes the invention with respect to currently available hand-held game controllers and support apparatus, but this invention may be easily modified to accommodate any current or future hand-held game controller by simply modifying the shape and/or size of the hand grip or its seating surface. Likewise, changes in available forms of mount features or support apparatuses may require a corresponding change in the design of the disclosed hand grip. Consequently, it should be understood that the exemplary embodiments described herein are intended to serve as examples to better explain the disclosed invention and should not be interpreted as limiting the scope of this invention. The disclosed hand grip invention includes any existing and future embodiments that are compatible with the characteristics and functionalities in this document.

1. A hand grip adapted for use with a hand-held game controller, wherein the hand-held game controller is coupled with a controller attachment means, the hand grip comprising:
a body having a seating surface adapted to accept coupling with the hand-held game controller by the controller attachment means; and
a first attachment means coupled with the body and adapted to attach the body to a support apparatus.

2. The hand grip of claim 1, wherein the first attachment means is further adapted to fixedly attach the body to the support apparatus.

3. The hand grip of claim 2, wherein the first attachment means comprises a threaded hole.

4. The hand grip of claim 2, wherein the first attachment means comprises a threaded bolt.

5. The hand grip of claim 2, wherein the first attachment means comprises a clamping mechanism.

6. The hand grip of claim 1, wherein the first attachment means is adapted to provide at least one degree of freedom of movement when coupling the body to the support apparatus.

7. The hand grip of claim 6, wherein the first attachment means is further adapted to enable at least partial rotation about at least one axis when coupling the hand grip with the support apparatus.

8. The hand grip of claim 6, wherein the first attachment means is further adapted to enable limited movement along at least one axis when coupling the hand grip with the support apparatus.

9. The hand grip of claim 6, wherein the seating surface further comprises a surface material that resists movement of the hand-held game controller when the hand grip is coupled with the support apparatus.

10. The hand grip of claim 1, wherein the seating surface is at least partly concave.

11. The hand grip of claim 1, wherein the seating surface is adapted to simultaneously contact at least two sides of the hand-held game controller.

12. The hand grip of claim 1, wherein the hand-held game controller is adapted for coupling with the controller attachment means while the game controller is simultaneously in contact with the seating surface.

13. The hand grip of claim 1, wherein the seating surface comprises a replaceable and interchangeable form element that is shaped to accommodate an external shape of a specific hand-held game controller model.

14. The hand grip of claim 1, wherein the hand grip is further adapted to enable actuation of at least one actuator of the hand-held game controller while both the hand-held game controller and the support apparatus are coupled with the hand grip.

15. The hand-grip of claim 14, wherein the first attachment means is adapted to enable positioning of the support apparatus while both the hand-held game controller and the support apparatus are coupled with the hand grip.

16. The hand-grip of claim 14, wherein the first attachment means is adapted to enable manual carrying of the support apparatus while both the hand-held game controller and the support apparatus are coupled with the hand grip.

17. A hand grip adapted for use with a hand-held game controller, wherein the hand-held controller is coupled with a controller attachment means, comprising:
a body having a seating surface adapted to accept coupling with the hand-held game controller by engagement with the controller attachment means; and
an integral support apparatus coupled with the body.

18. The hand grip of claim 17, wherein the body is adapted to enable actuation of at least one actuator of the hand-held game controller while the hand-held game controller is coupled with the hand grip.

19. The hand-grip of claim 17, wherein the controller attachment means is adapted to enable positioning of the hand-held game controller while coupled with the hand grip.

20. The hand grip of claim 17, wherein the hand grip is adapted to enable at least one degree of freedom of movement when coupled with the hand-held game controller.

21. The hand grip of claim 17, wherein the seating surface further comprises a surface material that resists movement of the hand-held game controller when the hand-held game controller is in contact with the seating surface.

22. The hand grip of claim 17, wherein the seating surface is at least partly concave.

23. The hand grip of claim 17, wherein the hand-held game controller is adapted for coupling with the controller attachment means while the game controller is simultaneously in contact with the seating surface.

24. The hand grip of claim 17, wherein the controller attachment means comprises a fastening mechanism that detachably couples the hand-held game controller into contact with the seating surface.

25. The hand grip of claim 17, wherein the controller attachment means comprises a fastening mechanism that permanently couples the hand-held game controller into contact with the seating surface.

26. The hand grip of claim 17, wherein the seating surface is adapted to simultaneously contact at least two sides of the hand-held game controller.

27. The hand grip of claim 17, wherein the integral support apparatus is adapted to accept fixed coupling with supported equipment.

28. The hand grip of claim 17, wherein the integral support apparatus comprises at least one cavity that facilitates the fixed coupling of a supported equipment with the integral support apparatus.

29. The hand grip of claim 2, wherein the first attachment means comprises a magnetic lock.

30. The hand grip of claim 1, wherein the controller attachment means comprises a fastening mechanism that detachably couples the hand-held game controller into contact with the seating surface.

31. The hand grip of claim 1, wherein the controller attachment means comprises a fastening mechanism that permanently couples the hand-held game controller into contact with the seating surface.

32. The hand grip of claim 1, wherein the controller attachment means comprises the seating surface and is adapted to simultaneously contact at least two sides of the hand-held game controller.
